(19) United States
(12) Patent Application Publication
(10) Pub. No.: US 2024/0190348 A1
(43) Pub. Date: Jun. 13, 2024

(54) TRAILER CAMERA DISPLAY SYSTEM

(71) Applicant: Stoneridge Electronics AB, Solna (SE)

(72) Inventor: Troy Otis Cooprider, White Lake, MI (US)

(21) Appl. No.: 18/524,098

(22) Filed: Nov. 30, 2023

Related U.S. Application Data
(60) Provisional application No. 63/430,701, filed on Dec. 7, 2022.

(51) Int. Cl. B60R 1/26; B60R 1/25; H04N 7/18

(52) U.S. Cl. CPC B60R 1/26; B60R 1/25; H04N 7/181; B60R 2300/105; B60R 2300/20; B60R 2300/802

(57) ABSTRACT

A camera monitoring system (CMS) for a vehicle includes a CMS controller that is connected to a plurality of cameras that are disposed about a vehicle and configured to receive a video feed from each of the cameras in the plurality of cameras, a first camera in the plurality of cameras defines a rear facing field of view. The CMS controller is configured to generate a plurality of display views using the video feeds, the plurality of display views include at least one rear facing display view. A first trailer rear view display is proximate a driver side A-frame. The CMS controller is configured to cause the first trailer rear view display to display the at least one rear facing display view.

### CROSS-REFERENCE TO RELATED APPLICATION

The present disclosure claims priority to U.S. Provisional Patent Application No. 63/430,701 filed Dec. 7, 2022.

### TECHNICAL FIELD

This disclosure relates to a camera monitoring system (CMS) for use in a commercial truck, and in particular to a system for providing communications between a sensor, such as a trailer-mounted camera, and the CMS.

### BACKGROUND

Mirror replacement systems, and camera systems for supplementing mirror views, are utilized in commercial vehicles to enhance the ability of a vehicle operator to see a surrounding environment. Camera monitoring systems (CMS) utilize one or more cameras to provide an enhanced field of view to a vehicle operator. In some examples, the mirror replacement systems cover a larger field of view than a conventional mirror, or include views that are not fully obtainable via a conventional mirror.

The area behind the trailer is a typical blind spot in a conventional mirror system. It is desirable to provide the operator visibility at the rear of the trailer. However, conventional mirror systems including a rearview mirror have the rear view obstructed by the trailer.

### BRIEF DESCRIPTION OF THE DRAWINGS

In one exemplary embodiment, a camera monitoring system (CMS) for a vehicle includes a CMS controller that is connected to a plurality of cameras that are disposed about a vehicle and configured to receive a video feed from each of the cameras in the plurality of cameras, a first camera in the plurality of cameras defines a rear facing field of view. The CMS controller is configured to generate a plurality of display views using the video feeds, the plurality of display views include at least one rear facing display view. A first trailer rear view display is proximate a driver side A-frame. The CMS controller is configured to cause the first trailer rear view display to display the at least one rear facing display view.

In a further embodiment of any of the above, the first camera is a trailer camera that is positioned at a rear of the vehicle, and faces away from the vehicle.

In a further embodiment of any of the above, the trailer camera is a rear facing camera that is disposed on a trailer of the vehicle.

In a further embodiment of any of the above, the first trailer rear view display is positioned immediately proximate a vehicle side view display.

In a further embodiment of any of the above, the first trailer rear view display and the vehicle side view display are incorporated in a single housing.

In a further embodiment of any of the above, the first trailer rear view display is incorporated in a first housing and the vehicle side view display is incorporated in a second housing that is distinct from the first housing.

In a further embodiment of any of the above, the first trailer rear view display is disposed immediately above the vehicle side view display.

In a further embodiment of any of the above, the first trailer rear view display is disposed immediately below the vehicle side view display.

In a further embodiment of any of the above, the first trailer rear view display is disposed adjacent a vertical side of the rear view display.

In a further embodiment of any of the above, the CMS further includes a second trailer rear view display. The second trailer rear view display is positioned either on a passenger side A-frame or at a mid-top portion of a windshield.

In a further embodiment of any of the above, the CMS further includes a third trailer rear view display. The third trailer rear view display is positioned at the other of the passenger side A-frame and the mid top portion of the windshield.

In a further embodiment of any of the above, the CMS controller is configured to cause the second trailer rear view to display an identical view to the view that is displayed by the first trailer rear view display.

In a further embodiment of any of the above, the at least one rear facing display view includes a Class VIII view.

In a further embodiment of any of the above, the at least one rear facing display view is a rear view replacement view.

In a further embodiment of any of the above, the vehicle lacks a rear view mirror that is disposed on a windshield

In a further embodiment of any of the above, the first trailer rear view display is positioned on the driver side A-frame.

### BRIEF DESCRIPTION OF THE DRAWINGS

The disclosure can be further understood by reference to the following detailed description when considered in connection with the accompanying drawings wherein:

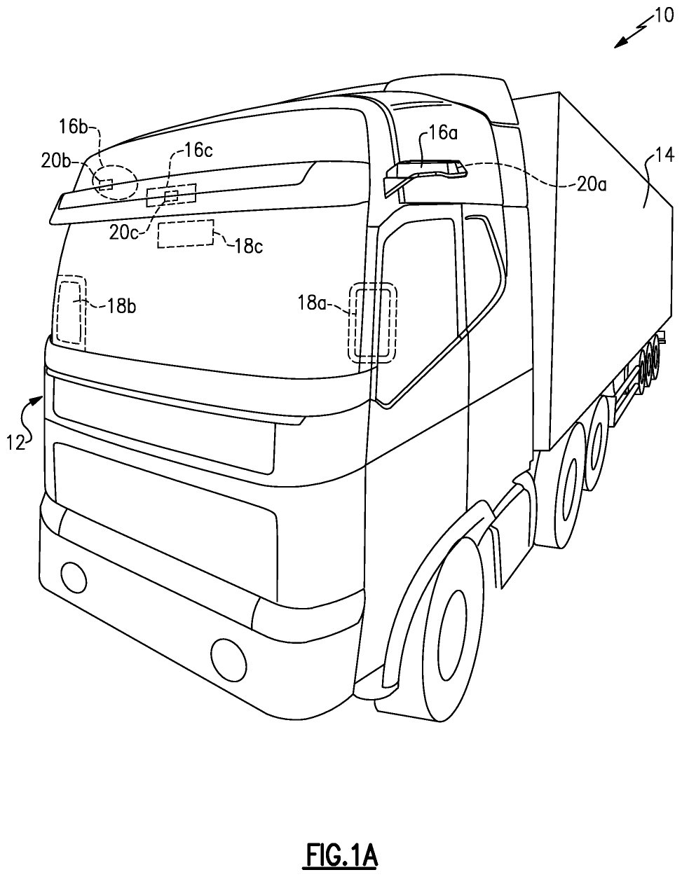

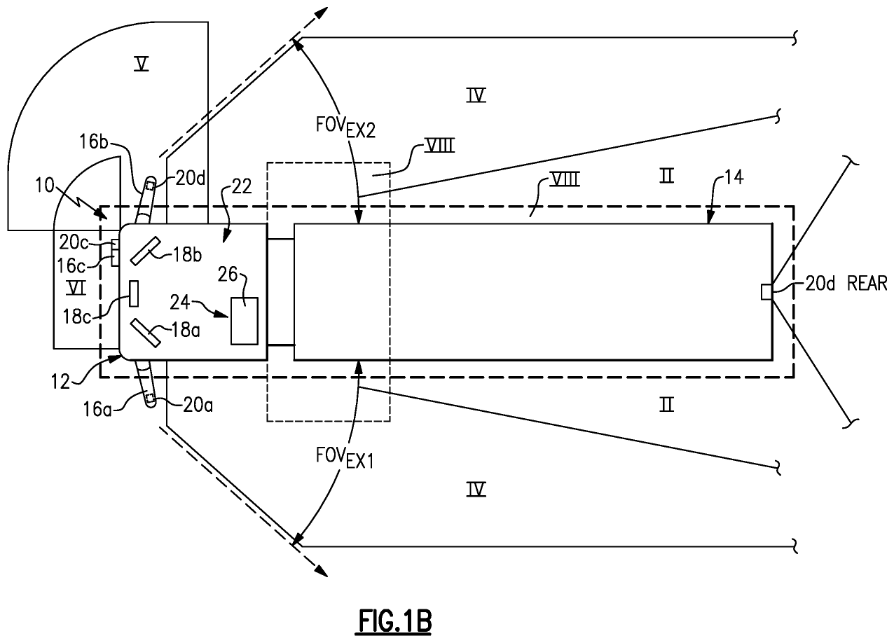

FIG. 1A is a schematic front view of a commercial truck with a camera monitoring system (CMS) used to provide at least Class II and Class IV views.

FIG. 1B is a schematic top elevational view of a commercial truck with a camera mirror system providing Class II, Class IV, Class V and Class VI views.

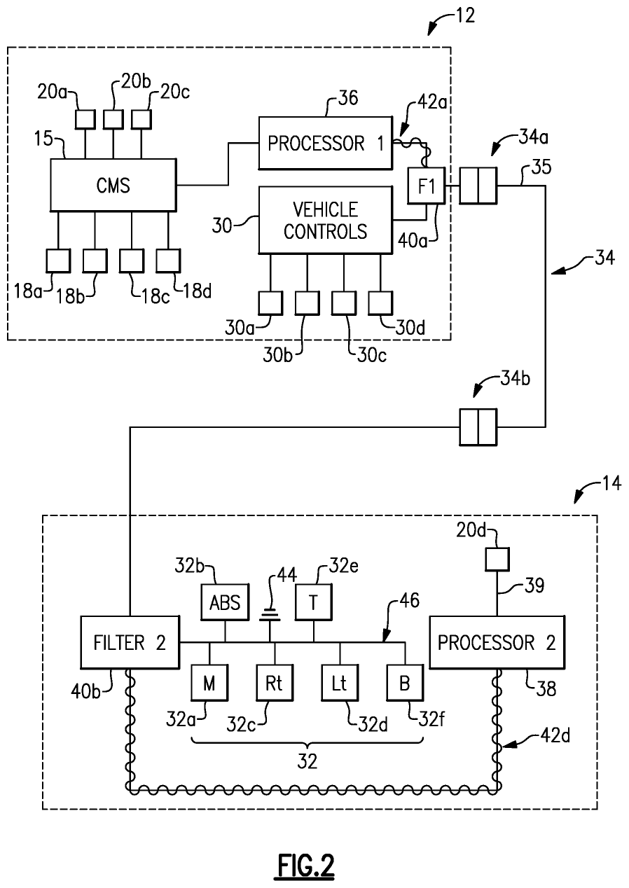

FIG. 2 is a schematic of a trailer camera communications system.

FIG. 3 is an end view of a trailer wiring harness connector.

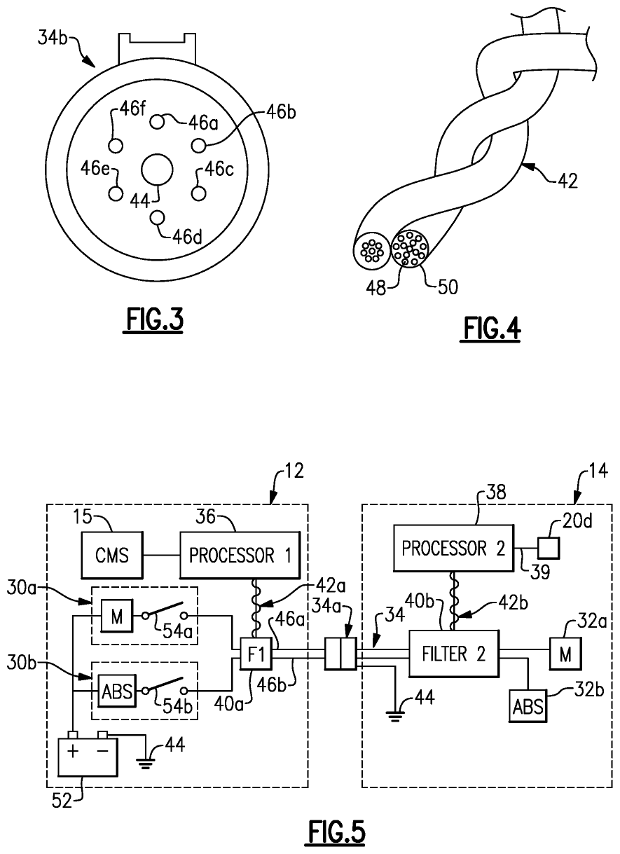

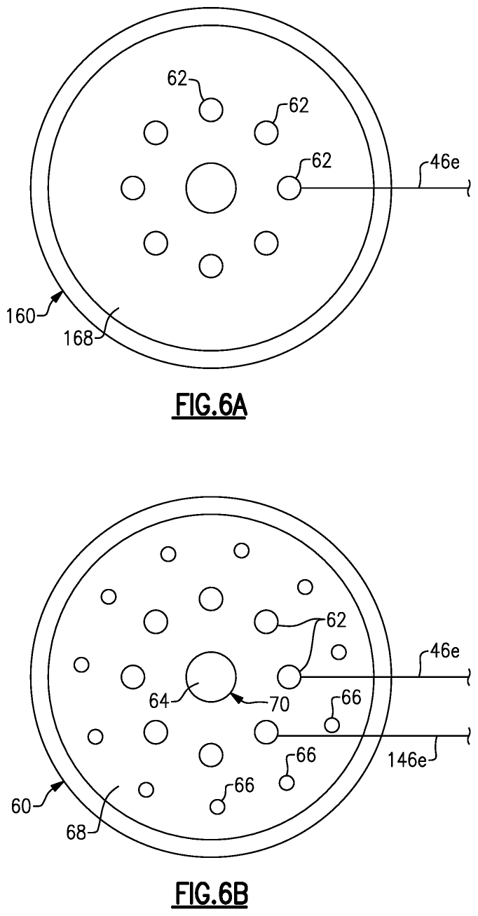

FIG. 4 depicts an unshielded twisted wire pair used to connect a processor and a filter in a trailer wiring harness.

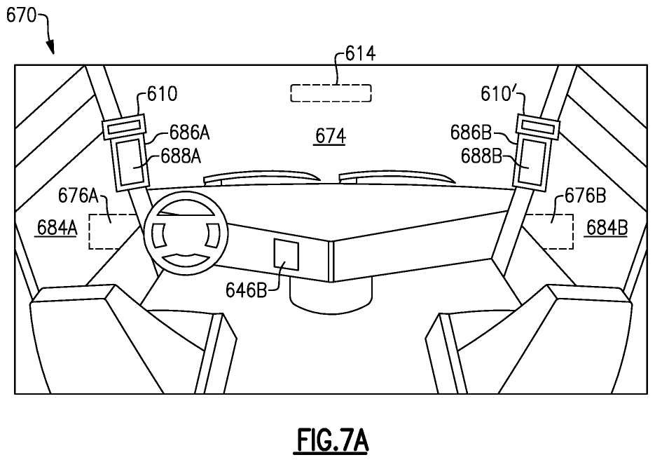

FIG. 5 is a schematic of an example implementation of the trailer camera communications system.

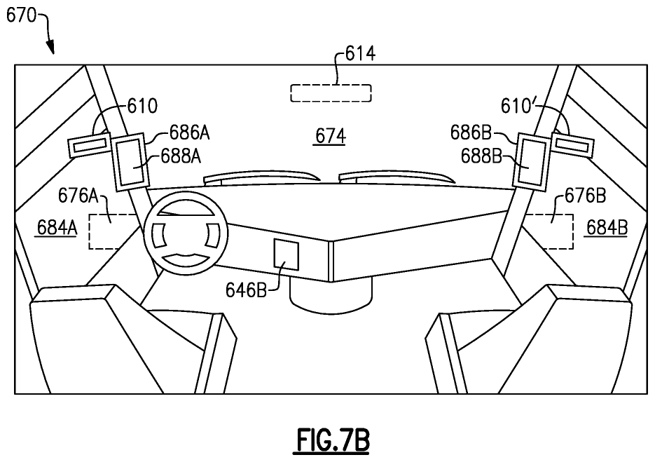

FIGS. 6A and 6B are examples of a sensor integrated into trailer light housings.

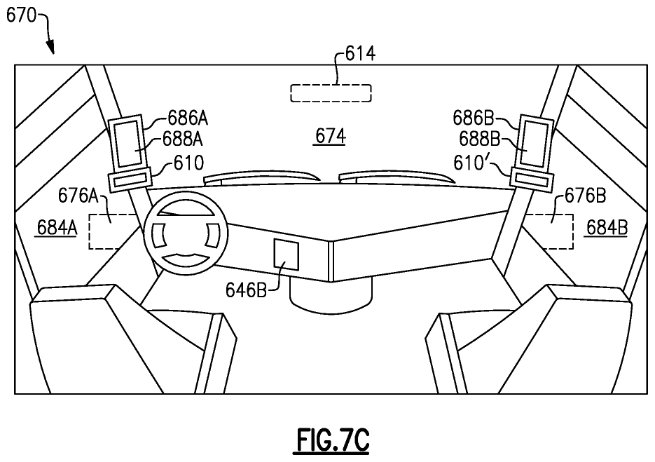

FIGS. 7A, 7B, and 7C are example vehicle cab views including a display for displaying images from a trailer camera to a vehicle operator.

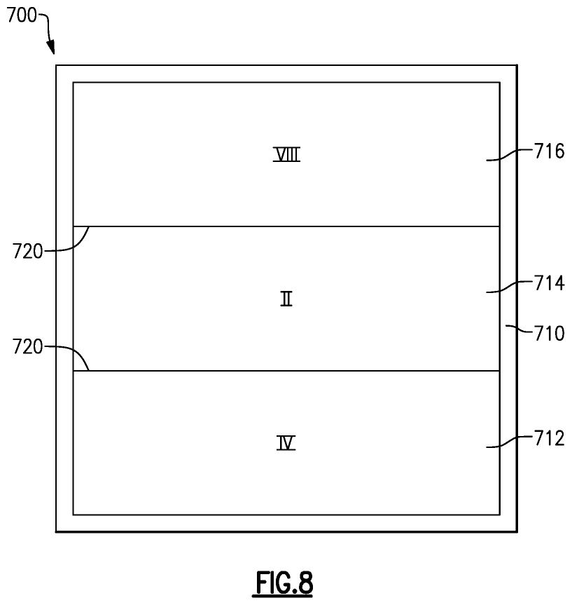

FIG. 8 illustrates an exemplary single screen configuration for displaying each of a Class II, Class IV, and Class VIII view simultaneously.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

A schematic view of a commercial vehicle 10 is illustrated in FIGS. 1A and 1B. The vehicle 10 includes a vehicle cab or tractor 12 for pulling a trailer 14. Although a commercial truck is contemplated in this disclosure, the disclosed system may also be applied to other types of vehicles. The vehicle 10 incorporates a camera monitoring system (CMS) 15 (FIG. 2) that has driver and passenger side camera arms 16a, 16b mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms 16, with each arm 16 housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within the camera arms 16a, 16b, e.g., the pivoting arms. The exterior cameras 20a, 20b respectively provide an exterior field of view FOV_{EX1}, FOV_{EX2} that each include at least one of the Class II and Class IV views (FIG. 1B) or similar views, which are legal prescribed views in the commercial trucking industry. The Class II view on a given side of the vehicle 10 is a subset of the Class IV view of the same side of the vehicle 10. Multiple cameras also may be used in each camera arm 16a, 16b to provide these views, if desired. Each arm 16a, 16b may also provide a housing that encloses electronics that are configured to provide various features of the CMS 15.

First and second video displays 18a, 18b are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b.

If video of Class V and Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver.

If video of Class VIII views is desired, camera housings can be disposed at the sides and rear of the vehicle 10 to provide fields of view including some or all of the Class VIII zones of the vehicle 10. As illustrated, the Class VIII view includes views immediately surrounding the trailer, and in the rear proximity of the vehicle including the rear of the trailer. In one example, a view of the rear proximity of the vehicle is generated by a rear facing camera disposed at the rear of the vehicle, and can include both the immediate rear proximity and a traditional rear view (e.g. a view extending rearward to the horizon, as may be generated by a rear view mirror in vehicles without a trailer). In another example, the Class VIII view can be generated by a rear facing camera mounted to the cab 12. In such examples, the view can be used when a trailer 14 is not connected (e.g., during a hitching operation). When a Class VIII view is desired, the third display 18c can include one or more frames displaying the Class VIII views. Alternatively, additional displays can be added near the first, second and third displays 18a, 18b, 18c and provide a display dedicated to providing a Class VIII view.

It should be understood that more or fewer displays can be used than schematically illustrated, and the displayed images from more than one camera may be combined on a single display, an image from a particular field of view may be provided on a separate, discrete display from another image, or images may be replicated on multiple displays in distinct locations.

The area behind the trailer 14 is a common blind spot for any vehicle, but particularly for commercial trucks. It is desirable to provide the operator some awareness of unseen objects at the rear of the trailer using a sensor, such as a camera 20d, as illustrated in FIG. 1B. Challenges to using a camera at the rear of a trailer 14 include the long run of wires that might be used to transmit a video signal to the display in the cab. Dedicated wiring adds significant cost to the system. Additionally, the images must be transmitted with minimal to no latency so objects are displayed in real time.

Referring to FIG. 2, the trailer 14 includes trailer components 32, such as a marker light 32a, an anti-lock braking system component 32b, a turn signal (right, 32c; left, 32d), a tail light 32e, and a brake light 32f. Each of the trailer components 32a-32f (collectively, trailer components 32) are responsive to a control signal from one or more vehicle controls 30, e.g., switches 30a-30d. The trailer components 32 on the trailer 14 are connected to the tractor 12 by a typical wiring harness 34. As an example, a standard 7-pin jumper cable 35 interconnects the tractor 12 and trailer 14 at connectors 34a, 34b, which are of a typical configuration (e.g., FIG. 3). As a result, the disclosed system can be used with the existing ubiquitous trailer wiring harnesses and electrical connectors in the industry.

There are various ground wires 44 in the system, only some of which are shown. Wires within a common wiring harness 34 are unshielded copper wire, typically multiple copper wire strands covered in a polymer insulation. For a standard 7-pin arrangement, shown in FIG. 3, a common ground 44 is provided, and control signals for the marker light 32a, the anti-lock braking system component 32b, the turn signal (right, 32c; left, 32d), the tail light 32e, and the brake light 32f are respectively sent over power wires 46a-46f.

The camera 20d has an image capture unit that generates a sensor signal that must be sent at a high transmission rate. The disclosed system accomplishes this transmission without the need for dedicated wiring running from the rear of the trailer 14 all the way to the tractor 12, which greatly simplifies installation and reduces cost. Desired sensor signal transmission is achieved over the very same power wires on the trailer 14 used to transmit control signals to the trailer components 32.

The tractor 12 has a first processor 36 that transmits the received sensor signal to the CMS 15 for display to the operator. A second processor 38 is arranged on the trailer 14 and interconnected between the sensor 20d and the wiring harness 34. The second processor 38 is configured to transform the sensor signal for transmission over the wiring harness 34 with the control signal using wires that are common with the wiring harness wires used to carry control signals to the trailer components 32. Said another way, several of the existing wires, e.g., a power wire and a ground wire, have a dual purpose: carrying a control signal and the sensor signal. An example chipset that may be used is available as VA6000 from Valens Semiconductor Ltd., although it should be understood that other processors can be used and fall within the scope of the disclosed system. Another example chipset is the DCB1M available from Yamar Electronics Ltd.

Noise is generated by the trailer components 32, such that a usable image signal may not be provided to the first and second processors 36, 38. So, first and second filters 40a, 40b are used at the signal tap locations, for example, respectively in the tractor and trailer wiring harness to filter out noise prior to transmission to the processors. Each of the filters 40a, 40b are connected to its respective first and second processor 36, 38 by an unshielded twisted pair of wires 42a, 42b (shown as “42” in FIG. 4). The twisted wire pairs are unshielded copper wire, typically multiple copper wire strands 48 covered in a polymer insulation 50, as shown in FIG. 4.

The second processor 38 includes an input, and the camera 20d is connected to the input by a high-speed transmission cable 39, such as an ethernet cable. The second processor 38 may be provided by a chipset that includes a processor and an encoder, which is configured to embed the sensor signal into the control signal for transmission along the power wire(s) to the first processor 36. Additional electrical devices may be connected to multiple inputs, if provided on the processor. The other inputs may accommodate, for example, IRLEDs associated with the camera 20d. The chipset may include a multiplexer configured to combine the inputs to provide the sensor signal as an output of the sensor along with outputs from the electrical devices.

The first processor 36 includes a decoder and a demultiplexer, which can be provided on the same chipset or separately, that are configured to isolate the sensor signal from the control signal. The decoder is provided by at least one of hardware and software.

At least one of the first and second processers 36, 38 are configured to perform pulse amplitude modulation to reduce noise in the control signal over the common power wires.

In operation, with reference to FIG. 5, the second processor 38 is configured to receive the sensor signal from the camera 20d and transmit the sensor signal to CMS controller 15. The second processor 38 embeds the sensor signal with the control signal on the power wires for the trailer components 32, such as over ABS and marker light power wires 46a, 48b. This combined sensor/control signal is transmitted along the trailer wiring harness 34 to the second filter 40b to filter any noise from the trailer components. Ideally, the second filter 40b is placed at a location and on power lines where the noise can be more easily filtered and to reduce the length of wires between the second filter 40 and the second processor 38.

The combined sensor/control signal is transmitted to the tractor 14 to a point “downstream” from vehicle component switches 54a, 54b to the first processor 36, where the sensor signal is decoded and transmitted to the CMS controller 15 for display. Each or both of the sensor signal and/or control signal may also be transmitted bi-directionally, if desired. The vehicle component switches 54a, 54b (e.g., trailer marker light switch and brake pedal) are connected to a power source 52, such as the vehicle's battery to selectively supply voltage, i.e., the control signal, to the trailer component. The first filter 40a must be located on the same pair of power transmission lines as the second filter 40b. The first filter 40 filters noise from the power wires to isolate the image signal sent from the second processor 38.

Although the sensor is described above as a camera 20d, it should be understood that other sensors may also be used in addition to or instead of a camera, such as a radar sensor, a lidar sensor, an infrared sensor and an ultrasonic sensor. In the case of a camera, it is desirable to transmit the sensor signal between the first and second processors 36, 38 and on to the CMS 15 over the common wires at a speed of at least 15 Mb/s. Compressing the sensor signal could result in undesired latency. The disclosed system is capable of achieving the desired transmission rate, without compression, with the minimal latency needed in a CMS system, i.e., less than 200 ms.

To provide further efficiencies, the sensor can be integrated into a light housing on the trailer 14, as shown in FIGS. 6A and 6B. Referring to FIG. 6B, a light housing 60 (e.g., a marker light, a tail light, a brake light and a turn signal) has the sensor 64, such as a camera 20d, provided in the housing 60. The lights 62 may be provided by LEDs 62 or incandescent bulbs for emitting visible light. An array of IR LEDs 66 powered by wires 146e may also be provided in the housing 66 if night vision is desired for the camera. The light housing 60 is sealed by a lens 68, which may cover the sensor as well. If desired, a separate lens 70 may be used over the sensor 64 and integrated with the lens 68, depending upon the application. The light housing 160 in FIG. 6A uses a lens 168 and with no IR LEDs.

Incorporating IR LEDs, and optionally a camera, into a ubiquitous taillight assembly would obviate the need for any specialized mounting brackets or hardware when adding night vision or another view at the rear of the trailer.

The controller in the CMS can be used to implement the various functionality disclosed in this application. The controller may include one or more discrete units. The first processor 36 can be incorporated into the CMS controller or separate, but the second processor 38 will be separate from the first processor 36 as the second processor resides on the trailer 14. Moreover, a portion of the controller may be provided in the vehicle, while another portion of the controller may be located elsewhere. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller may be a hardware device for executing software, particularly software stored in memory. The controller can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a display, macroclimate device, microclimate device, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

In some cases, the view generated by the rear facing camera 20d can encapsulate a field of view traditionally provided by a rear view mirror in a vehicle without a trailer. In such examples, the view can be provided to one or more display in the vehicle cabin and the CMS 15 can operate the display as part of a mirror replacement system or a mirror enhancement system in order to replace rear view mirror views that are partially or entirely obscured by an attached trailer.

Further, as the display is not a mirror, it can be positioned in a location other than the center top portion of the windshield while still displaying the conventional “rear view mirror” view. Shifting the positioning from the mid-top of the windshield can reduce costs in some examples via shortening the length of wire required to provide view to a display, provide safety benefits in some examples by positioning the rear view in a location visible to the operator without requiring the operator to look away from the road, and can allow the operator to view both a side view and rear view of the vehicle simultaneously. Further, these benefits can be combined such that multiple of the benefits can be achieved within a single system.

One position that can advantageously achieve these benefits is mounting the display 610 to the driver side A-frame, or positioning the display 610 proximate the A-frame near the side view display. As used herein, “proximate the A-frame”refers to a position that is near to the A-frame such that a vehicle operator looking to a feature mounted on the A-frame will see the display 610 near the center of their field of vision.

FIGS. 7A, 7B, and 7C illustrate exemplary configurations with a rear view mirror display 610 positioned on the driver side A-frame. In each example the rear view mirror display 610 is positioned proximate a corresponding side view display 688A (e.g., a class II/IV view display). Aside from the positioning of the rear view mirror display 610, each of 7A, 7B and 7C illustrate substantially identical vehicle cabins.

Referring now to FIG. 7A, an example vehicle cabin 670 is schematically shown. Included in the cabin 670 is a windshield 674, wing mirrors 678A-B, and an instrument cluster display 646A. The example vehicle also includes a center console display 646B and camera monitoring system (CMS) displays 688A-B positioned on each of the A-frames 692A-B. Each CMS display 688A-B is included within a corresponding housing 686A-B. In some examples, where the CMS operates as a mirror replacement system, the wing mirrors 676A-B can be omitted entirely and the displays 688A-B provide Class II/IV views as described above to replace the views provided by the wing mounted mirrors 676A-B.

Also mounted on one of the A-frames 692A is a rearview monitor 610. The rear view monitor 610 is configured to replace the traditional rear view mirror 612A for vehicles where the rear view mirror is not always functional, such as vehicles for pulling a trailer. In another optional example, a second display 610′ can be positioned on the passenger side A-frame 692B, with the second display 610′ in the same position relative to the passenger side monitor 688B as the main rear view display 610 is relative to the driver side monitor 688A. In alternative examples, another rear view monitor 610″ can be positioned in the traditional location 614 in addition to the monitor 610 positioned on the A-frame 692A. In each of the alternate examples, the monitors 610, 610′, 610″ display the same view.

By mounting the rear view display 610 adjacent the CMS monitor 688A and the A-frame 692A, the rear view display 610 is maintained within the peripheral vision of the vehicle operator during all vehicle operations, and the operator is not required to alter their gaze to check the rear view. In addition, when the driver side positioning is the sole rear view display 610, the length and number of wires required to run from the CMS controller to the displays can be minimized reducing both cost and system complexity.

Furthermore, in the examples where the redundant monitors 610′ and 610″ are utilized the positioning at the passenger side A-frame 692B and in the mid-top of the windshield further ensures that a rear view is presented to the vehicle operator at all times during operation, regardless of which direction the operator has shifted their gaze.

With continued reference to FIG. 7A. FIG. 7B illustrates the same vehicle cab, with the rear view monitor 610 shifted to an exterior (away from the center of the vehicle) side of the CMS monitor 688A. As with the example of FIG. 7A, an optional secondary display 610′ is positioned in the same position relative to the passenger side display 688B as the rear view display 610 is positioned relative to the driver side display 688A.

With continued reference to FIGS. 7A and 7B, FIG. 7C illustrates the same vehicle cab 670 with the rear view monitor 610 shifted again to a position below the driver side monitor 688A. As with the examples of FIGS. 7A and 7B, an optional secondary display 610′ is positioned in the same position relative to the passenger side display 688B as the rear view display 610 is positioned relative to the driver side display 688A,

In one example, the camera monitor system units 86A-B are part of the MIRROREYE system from Stoneridge, Inc.

With reference to each of FIGS. 7A-7C, in the illustrated examples, the rear view display(s) 610, 610′ are contained within the same display housing 686A, 686B as the corresponding displays 688A, 688B. In alternative constructions, the rear view display(s) 610, 610′ are contained within distinct housings and the housings for the rear view display(s) 610, 610′ are positioned proximate to the corresponding housings 686A-B.

With continued reference to FIGS. 7A-7C, FIG. 8 schematically illustrates an example display 700 capable of operating simultaneously as the rear view monitor 610 and the driver side display 688A. In alternative examples a similar or identical display can be utilized in any other positioning (e.g. the passenger side display 688B or a enter dash monitor) for similar purposes.

The display 700 includes a single screen 710 with three display regions 712, 714, 716. The bottom display region 712 displays a Class IV view, the middle display region 714 displays a Class II view, and the top display region 716 displays a Class VIII view. In the example embodiment, each of the regions 712, 714, 716 is separated from each of the other regions 712, 714, 716 by a visually displayed border 720. While positioned in the example display 700 as evenly spaced with each region 712, 714 having identical dimensions, it is appreciated that in other examples the regions 712, 714, 716 can have varying dimensions with appropriate borders 720.

In some examples the positioning of the borders 720 and/or the dimensions of the regions 712, 714, 716 can be fixed throughout operation of the CMS 15. In other examples, the positioning of the borders 720 and/or the dimensions of the regions 712, 714, 716 can be adjusted either manually by the vehicle operator or automatically by the CMS 15 depending on the current needs of the display 700 and/or the current mode of vehicle operation.

Although an example embodiment has been disclosed, a worker of ordinary skill in this art would recognize that certain modifications would come within the scope of the claims. For that reason, the following claims should be studied to determine their true scope and content.

What is claimed is:

1. A camera monitoring system (CMS) for a vehicle, comprising:
a CMS controller connected to a plurality of cameras disposed about a vehicle and configured to receive a video feed from each of the cameras in the plurality of cameras, a first camera in the plurality of cameras defining a rear facing field of view;
the CMS controller being configured to generate a plurality of display views using the video feeds, the plurality of display views including at least one rear facing display view;
a first trailer rear view display proximate a driver side A-frame; and
wherein the CMS controller is configured to cause the first trailer rear view display to display the at least one rear facing display view.

2. The CMS of claim 1, wherein the first camera is a trailer camera positioned at a rear of the vehicle, and facing away from the vehicle.

3. The CMS of claim 2, wherein the trailer camera is a rear facing camera disposed on a trailer of the vehicle.

4. The CMS of claim 1, wherein the first trailer rear view display is positioned immediately proximate a vehicle side view display.

5. The CMS of claim 4, wherein the first trailer rear view display and the vehicle side view display are incorporated in a single housing.

6. The CMS of claim 4, wherein the first trailer rear view display is incorporated in a first housing and the vehicle side view display is incorporated in a second housing distinct from the first housing.

7. The CMS of claim 4, wherein the first trailer rear view display is disposed immediately above the vehicle side view display.

8. The CMS of claim 4, wherein the first trailer rear view display is disposed immediately below the vehicle side view display.

9. The CMS of claim 4, wherein the first trailer rear view display is disposed adjacent a vertical side of the rear view display.

10. The CMS of claim 1, further comprising a second trailer rear view display, the second trailer rear view display being positioned either on a passenger side A-frame or at a mid-top portion of a windshield.

11. The CMS of claim 10, further comprising a third trailer rear view display, the third trailer rear view display being positioned at the other of the passenger side A-frame and the mid top portion of the windshield.

12. The CMS of claim 10, wherein the CMS controller is configured to cause the second trailer rear view to display an identical view to the view displayed by the first trailer rear view display.

13. The CMS of claim 1, wherein the at least one rear facing display view includes a Class VIII view.

14. The CMS of claim 1, wherein the at least one rear facing display view is a rear view replacement view.

15. The CMS of claim 14, wherein the vehicle lacks a rear view mirror disposed on a windshield.

16. The CMS of claim 1, wherein the first trailer rear view display is positioned on the driver side A-frame.
